(19) United States
(12) Patent Application Publication
(10) Pub. No.: US 2023/0316000 A1
(43) Pub. Date: Oct. 5, 2023

(54) GENERATION OF CONVERSATIONAL RESPONSES USING NEURAL NETWORKS

(71) Applicant: Nvidia Corporation, Santa Clara, CA (US)

(72) Inventors: Purnendu Mukherjee, San Jose, CA (US); Vlad Getselevich, Los Gatos, CA (US); Ryan Leary, Woodstock, GA (US)

(21) Appl. No.: 17/713,470

(22) Filed: Apr. 5, 2022

(51) Int. Cl. G06F 40/35; G06F 40/56; G06N 3/04

(52) U.S. Cl. CPC G06F 40/35; G06N 3/0454; G06F 40/56

(57) ABSTRACT

Systems and methods determine an answer to an input query and provide a conversational response. The answer may be determined using a trained first neural network to extract the answer from a corpus of information. The answer and the input query may be provided to a second trained neural network to generate a formulation of the input query combined with the answer in order to generate a conversational response.

### BACKGROUND

Interactive environments may include conversational artificial intelligence systems that receive a user input, such as a voice input, and then infer an intent in order to provide a response to the input. Systems may include extractive question answering models, where a response to an input is extracted from a block of text, or generative models, where an answer may be articulated based on the input. Often, responses from these systems are not conversational, such as providing a one word answer. Additionally, responses may not be trusted because a generative system may add information not found within a data source. Attempts to fine tune these models or hard code conversational responses are time consuming and resource intensive, thereby limiting applicability of these models.

### BRIEF DESCRIPTION OF THE DRAWINGS

Various embodiments in accordance with the present disclosure will be described with reference to the drawings, in which:

FIG. 1 illustrates an example of a pipeline query response generation, according to at least one embodiment;

FIG. 2 illustrates an example environment for query response generation, according to at least one embodiment;

FIG. 3A illustrates an example environment for query response generation, according to at least one embodiment;

FIG. 3B illustrates an example environment for query response generation, according to at least one embodiment;

FIG. 4 illustrates an example process flow for query response generation, according to at least one embodiment;

FIG. 5 illustrates an example flow chart of a process for query response generation, according to at least one embodiment;

FIG. 6 illustrates an example flow chart of a process for query response generation, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

Approaches in accordance with various embodiments provide systems and methods for providing articulated, conversational responses in an interaction environment. In at least one embodiment, a pipeline utilizes an extractive question answering (EQA) model to retrieve an answer responsive to an input query. This answer may then be passed to a zero-shot generative model to develop a conversational response. The zero-shot generative model may be referred to an answer extender (AE) that takes, as inputs, both the answer from the EQA as well as the initial input query. The AE may then determine how to rephrase the input query such that the answer may be inserted to provide a conversational response to the input query.

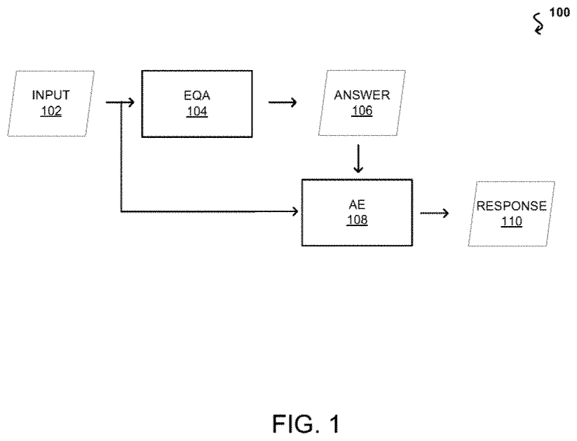

Various embodiments of the present disclosure may enable one or more conversational artificial intelligence (AI) systems to provide a conversational response more akin to how a human would respond to an input question while providing a lighter weight, easier to train, and easier to deploy system when compared to existing approaches. For example, embodiments may overcome problems with existing approaches that provide non-conversational responses (e.g., one word or phrase responses) or incorrect responses, which may reduce a user experience and cause a user to be less likely to utilize the services in the future. A conversational AI pipeline 100, illustrated in FIG. 1, includes a combination of two trained models arranged in a sequence in order to generate a response to an input query. In at least one embodiment, two or more different neural network architectures may be utilized within a sequential pipeline in order to obtain the advantages of each network while addressing the shortfalls in existing systems, such as extensive task or domain specific training prior to launch. For example, systems and methods may utilize the EQA model in order to obtain an answer from an initial input query coupled with a generative AE model in order to generate a response. By combining these two models, deficiencies in both EQA and generative models can be addressed and limited.

Systems and methods may overcome problems associated with EQA models where an answer (e.g., a span of words) is obtained from a provided context set. While these models may be trained to identify an appropriate span given an input, the results are provided in the form of the context set and not in a conversational manner. For example, if the context set included a series of sentences and a particular phrase was associated with an answer, the EQA model would output the phrase alone, which may not provide a satisfactory interaction for a user. A rules-based model may take the output in an attempt to form a conversational response, but these rules are generally hardcoded for each system and, as a whole, may have very limited use cases. Regarding a generative model, the answer provided may not be reliable because these models can deviate or otherwise stray from a given data source, which may lead to an answer with extra or added information. This extra information may come from pre-training that persists based on model weights. Generative systems, when used as standalone responses in interaction environments, such as chat bots, require extensive fine tuning on domain specific datasets in order to provide accurate answers. As a result, large data sets are either created or obtained for specific domains, processed, and then utilized for training fine/tuning prior to utilization to attempt to reduce or otherwise eliminate the wrong or unreliable answers.

Systems and methods may provide improved results for conversational AI systems, such as chat bots. Embodiments include a pipeline that combines EQA along with an AE in order to utilize the input question to generate an answer that sounds natural or like a conversation. As an example, a user may provide an input that includes a question to a trained EQA model that includes a set of information. The input may contain both a query and a context. The information responsive to the question may be extracted as the answer, for example based on the provided context. This answer may then be provided to the AE, along with the initial input query, so that the initial input query can be reformulated and combined with the answer to provide a conversational response. However, if the answer is not in the information associated with the EQA model, an alternative response may be provided, such as an indication to the user that an answer to the query is unavailable. In at least one embodiment, the alternative response may also request the user reformulate or otherwise provide an alternative input. The AE may be a task-specific model that is trained to rearrange the input question so that it can be reformulated in a way that sounds like a natural response. The system enables development of a conversational AI system that may provide improvements in the answer and also provide greater reliability than generative models that may provide erroneous answers in the event that the actual answer is unknown or unclear. Additionally, deployment of EQA and AE models may be less resource intensive when compared to other models that use significantly more parameters.

In the illustrated example, the trained models may include the EQA and AE models where the EQA model corresponds to a zero-shot model and the AE corresponds to a generative model. Various embodiments enable a query to submit an input, which may include both a query and a context, to an interface associated with a conversational AI system, by way of example. It should be appreciated that conversational AI systems may be discussed by way of example only, and that systems and methods may be utilized in other machine learning or AI situations where information is sought after.

In this example, an input 102 is received by a system, for example a conversational AI system, at an interface. The input 102 may include a query and a context. For example, the query may correspond to a question or data sought after in the input 102. The context may be the form or presentation in which the query is presented. As an example, an input that corresponds to a phrase such as “What is the car color?” includes a query (e.g., car color) and the context (e.g., the structure of the input). As will be described below, the context may be utilized in order to rephrase or otherwise rearrange the input to insert a determined answer responsive to the query.

In various embodiments, the input 102 may be an auditory input provided by a user to a conversational AI system, which may include a kiosk or voice assistant. In at least one embodiment, the input 102 is a textual input, such as one provided by a user operating a user device which includes a chat bot, where an interface allows the user to enter the input. The input 102 may undergo one or more processing or pre-processing steps, such as through one or more natural language processing (NLP) systems that evaluate an auditory or textual input to extract one or more features from the input, among other options. Furthermore, in embodiments, input processor may include a text processing system for preprocessing (e.g., tokenization, removal of punctuation, removal of stop words, stemming, lemmatization, etc.), feature extraction, and the like. It should be appreciated that one or more trained machine learning systems may further be incorporated into the conversational AI pipeline 100, but have been removed here for clarity with the present discussion.

The query may be extracted from the input 102 and provided to an EQA model 104, which may determine an answer 106. The EQA model 104 may be a trained neural network that is utilized to extract one or more portions of an input sequence to answer a natural language question associated with such a sequence. As an example, for an input such as “what colors can I paint the car” unstructured text may be evaluated to identify potential colors for the car, where those colors may then be presented to the user. For example, if the provided context includes a block of text such as “car colors are white, black, red, yellow, and gray” then the answer to the query would be “white, black, red, yellow, and gray.” Additionally, it should be appreciated that EQA may also be utilized with intent/slot evaluations. In various embodiments, the EQA model may be a trained neural network system, such as NeMo from NVIDIA Corporation.

In at least one embodiment, the EQA model 104 may be particularized for a certain situation or task through the use of a block of information or provided context. For example, a generalized EQA model may be trained to extract, for a given block of text, information based on an input. However, different blocks of text may be utilized for a given scenario, such as a first block of text for a first chat bot, a second block of text for a second chat bot, and the like. In this manner, the model may be turned or otherwise adapted for different scenarios as long as the model is capable of extracting the relevant portions of an input from a block of text or other types of provided context.

The EQA model 104 may evaluate the input to identify the answer 106 from the provided context. However, that answer 106 may not be conversational, but may be a sequence or span of words or phrases corresponding to the input. For example, an input of “What color is the car?” may return an answer of “yellow” for a yellow car. While this answer is correct, and provide information to the user, it is not conversational and may provide an unpleasant user experience. Accordingly, embodiments of the present disclosure may further incorporate an AE model 108 into the illustrated pipeline in order to reformulate the answer 106 into a conversational response 110. The AE model 108 may further receive the initial input 102 when reformulating the answer 106 into the conversational response 110. For example, the AE model 108 may evaluate the input 102, extract one or more features associated with how a query was presented, and then generate the response 110.

In various embodiments, the AE model 108 is a generative model, which may be a zero-shot model. The AE model 108 may be trained such that no new information is added (e.g., additional answers are not provided), but only information provided to the AE model 108 is used to generate the response 110. For example, the generative model may create a sentence, but will not add additional information to expand or otherwise modify the answer 106. In at least one embodiment, the AE model 108 may be topic-agnostic, but task-specific. That is, regardless of the answer 106 provided to the AE model 108, a conversational response 110 will be generated. For example, the model may be trained on a particular language, such as the English language, to identify semantic rules and parts of speech in order to generate sentences or phrases. In at least one embodiment, the AE model 108 may be a BERT model that is pre-trained on a specific data set to illustrate how answers may be rewritten. Accordingly, the AE model 108 may need to be trained only to rewrite or otherwise reformulate answers given a set of inputs and not to generate or otherwise add new information to an answer. Accordingly, this model may be added to the illustrated sequential pipeline in order to generate the response 110 based on the answer 106 and/or the input 102.

Various embodiments of the present disclosure may provide for the illustrated pipeline 100 to leverage benefits of the EQA model 104 and the AE model 108 while reducing drawbacks or other deficiencies provided by each model individually. For example, as noted above, while various EQA models may be sufficient in providing answers from a corpus of information, the answers are typically non-conversational. Furthermore, trying to hardcode or otherwise generate a rules-based model to reformulate these non-conversational answers is often difficult, results in poor outcomes, or may be unfeasible due to individual rules being generated for different situations in which the model is deployed. Generative models, such as the AE model, may provide unreliable answers because the answers may deviate from the data source or the provided context by adding information learned during pre-training. As a result, the answer generated from the generative models may be conversational, but accuracy is questionable. By combing both the EQA and AE models, embodiments of the present disclosure provide a conversational AI system that may provide conversational responses with improved accuracy and lower latency than existing methods. Furthermore, various embodiments may provide lighter weight models that can be run on premises, thereby providing a greater number of areas where such a system can be deployed.

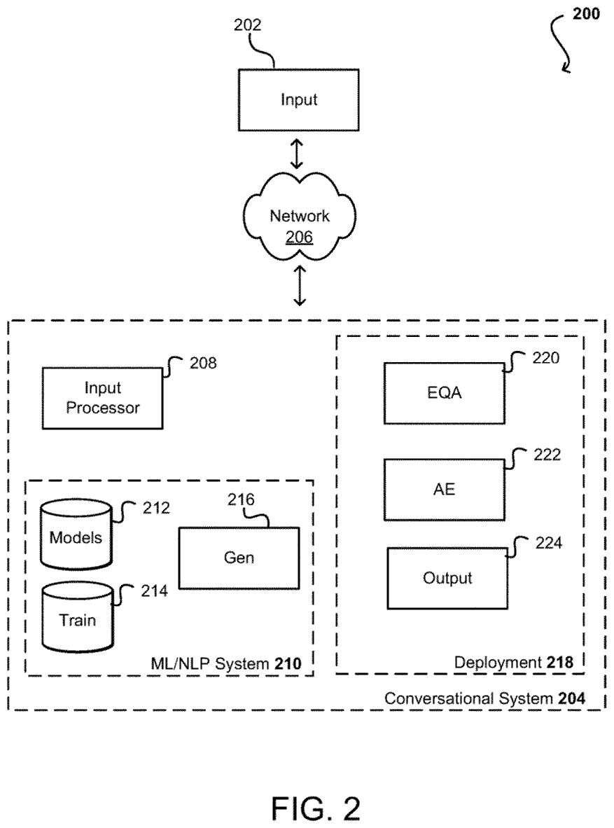

An environment 200 may be utilized with one or more conversational AIs, as shown in FIG. 2. It should be appreciated that the environment 200 may include more or fewer components and that various components of the environment 200 may be incorporated into singular systems, but may be shown as separate modules for convenience and clarity. In this example, an input 202 is transmitted to a conversational system 204 via one or more networks 206. The networks 206 may be wired or wireless networks which include one or more intermediate systems, such as user devices, server components, switches, and the like. Moreover, it should be appreciated that one or more features of the conversational system 204 may be pre-loaded or otherwise stored on a user device such that transmission of at least a portion of data may not utilize the network 206 but may be performed locally on a device.

The environment 200 may include one or more processing units, which may be locally hosted or part of one or more distributed systems. In this example, the input 202 may be provided at a local client, which may include one or more electronic devices that are configured to receive a user input, such as a voice input, and is communicatively coupled to additional portions of the architecture 200, either through on-system memory or via one or more network connections to one or more remote servers. The input 202 may be a speech input, such as a user utterance that includes one or more phrases, which may be in the form of a question (e.g., query) or a command, among other options. It should be appreciated that the speech input is provided by way of example and various embodiments may further include a textual input, an image input, or a selection of an interaction element, among other options. For example, the user may type a question into a chat box. In another example, the user may upload an image which includes text that is evaluate and extracted. In a further example, the user may select one of a series of options. It should be appreciated that the input may include combinations of inputs, such as an auditory input accompanied by a textual input. In this example, the local client may provide access to an conversational system 204 via one or more software programs stored on and/or executed by the local client. By way of example, the local client may include a kiosk positioned to assist individuals navigate an area or to answer questions or queries, the kiosk may include software instructions that are configured to provide users with access to the capabilities of the interaction environment. In another embodiment, the local client is a user device running a connected interface (e.g., an app, a website, etc.).

In operation, the user provides the input 202 to the local client, which may further include one or more input processors 208. By way of example, the input processor 208 may perform one or more pre-processing steps, as well as evaluation of the speech, image, and/or textual input, such as via automatic speech recognition, text-to-speech processing, natural language understanding, and the like. Moreover, it should be appreciated that one or more of these functions may be performed on the local client or the local client may transmit the input to the input processor 208 for processing, such as transmitting portions of an audio stream. It should be appreciated that various processing steps may be performed before or after the transmission, for example word stemming or compression in order to reduce a size of the transmission.

The input processor 208 may include one or more NLP systems that evaluate an auditory input to extract one or more features from the input, among other options. Furthermore, in embodiments, input processor 208 may include a text processing system for preprocessing (e.g., tokenization, removal of punctuation, removal of stop words, stemming, lemmatization, etc.), feature extraction, and the like. Moreover, various embodiments may further include automatic speech recognition (ASR), text-to-speech processing, and the like. One such example of these systems may be associated with one or more multimodal conversational AI services, such as Riva from NVIDIA Corporation. It should be appreciated that the input processor 208 may utilize one or more trained machine learning systems and may further be incorporated into other components of the conversational system 204.

This example includes a machine learning/NLP system 210 that may be utilized to develop, train, and launch different machine learning systems, such as those utilized with various EQA and AE systems. In this example, the system 210 includes a model data store 212 and a training data store 214. It should be appreciated that more data stores may be utilized and that individual types of models or sets of training data may come from different data stores. The model data store 212 may include different types of machine learning models that may be utilized with various embodiments, such as NLP systems, EQA models, AE models, and the like. In various embodiments, previously trained models may be stored within the model data store 212 and launched when a call is received at various conversational systems.

In various embodiments, training data may be utilized to train and/or fine tune various machine learning systems. The training data may come from various data sets, such as MSMARCO, where different portions or sets of data may be extracted or grouped together for different purposes. For example, different data sets may be utilized in order to fine tune or otherwise make a task-specific model. In contrast, task-agnostic models may also be generated. For example, one or more EQA models may be trained to extract spans from a corpus of information while one or more AE models may be generally trained to evaluate and reformulate an answer. A model generator 216 may launch or otherwise prepare different models for use, such as by providing a corpus of information to various EQA models.

A deployment system 218 includes an EQA model 220, an AE model 222, and an output generator 224. The EQA model 220 may be selected, at least in part, based on one or more properties of the deployment 218, for example an application associated with the deployment 218. For example, for a chat bot with a particular set of characteristics, the EQA model 220 may be selected where the provided context corresponds to information associated with that chat bot. However, as noted above, in at least one embodiment, the AE model 222 may be topic agnostic, and as a result, a single AE model 222 may be utilized with a variety of different EQA models. The output generator 224 may receive the response generated from the AE model 222 and then determine how to present the information to the user, for example, as a textual output, an auditory output, or combinations thereof. In this manner, a conversational system 204 may deploy different configurations of machine learning systems to support a variety of different scenarios.

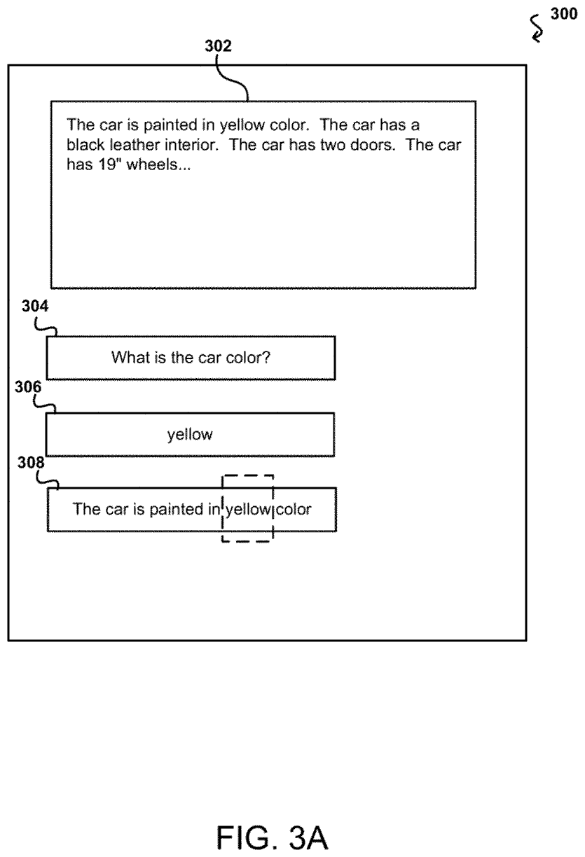

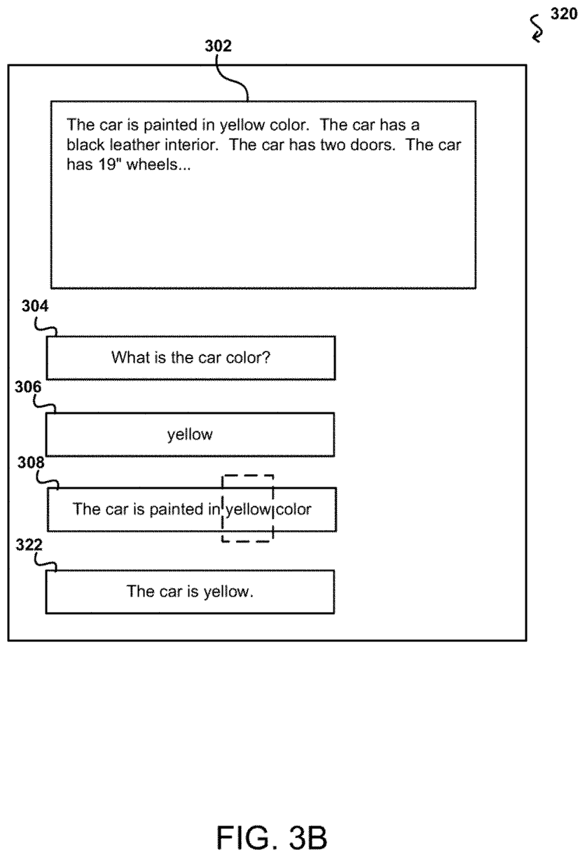

As noted herein, various embodiments enable identification of information within a provided context (e.g., a corpus of text, a data source, etc.) using one or more trained machine learning systems, such as an EQA model. However, such a model often provides answers that are not conversational, and therefore, may have limited use in certain situations, such as chat bots or digital assistants where a user may want to feel as if they are having a conversation or otherwise receive information in a natural manner. An interaction environment 300 includes a set of information 302, as illustrated in FIG. 3A. This set of information 302 may correspond to the provided context in that answers responsive to user queries will be identified within the set of information 302. This example provides the set of information 302 as free text in a natural language format, which in this case is a series of sentences. It should be appreciated that different unstructured memory schema may be used, such as lists (e.g., colors are white, black, red, yellow, and grey), key value pairs (e.g., colors: white, black, red, yellow, grey), and the like. It should be appreciated that the information may be provided in a variety of different formats.

An input 304 shows an example query provided to the environment 300, which in this case is a question. It should be appreciated that the input 304 may be a textual input (e.g., the user typed it in), an auditory input (e.g., a voice interaction), or the like. As noted above, for auditory inputs one or more NLP systems may convert the speech to text. Additionally, for other inputs, one or more machine learning systems may also be utilized to extract information indictive of the query. It should be appreciated that the input 304 is provided as an example to illustrate the process evaluated by the environment 300 and that, in embodiments, the user utilizing the environment will not be able to see the set of information 302 and/or the input 304. That is, the environment 300 may execute in the background while a different user interface is shown to the user. In this example, the input 304 corresponds to a question, which may be identified by one or more classifiers. Moreover, in various embodiments, the question may be further analyzed to determine whether it is an information-based question.

In at least one embodiment, an answer 306 is extracted from the set of information 302, for example using the EQA model. For example, the EQA model may be trained to evaluate portions of the set of information 302 to identify certain words or features and then return the answer 306. However, as noted above, providing the answer alone may be insufficient as the user may want a more natural interaction. As shown, the passage context 308 may correspond to the portion of the set of information 302 from which the answer was obtained. In this case, the sentence that includes the answer is shown, with the answer 306 identified by the bounding box with broken lines. Embodiments of the present disclosure utilize this context along with the input in order to generate a conversational response.

An interaction environment 320 includes the set of information 302, the input 304, the answer 306, and the passage context 308, as illustrated in FIG. 3B. As noted with respect to FIG. 3A, the set of information 302 may be particularly selected for the given environment 320, the input 304 may be provided by a user, the answer 306 may be determined via one or more EQA models, and the passage context 308 may correspond to the sentence or span within the set of information 302 where the answer 306 was identified. However, in this example, a response 322 may be generated, for example using the AE model, based, at least in part, on the input 304 and the context 308. This response 322 may then be provided to the user in one or more forms (e.g., textual, auditory, etc.) to provide an improved response that is more conversational than merely providing the answer.

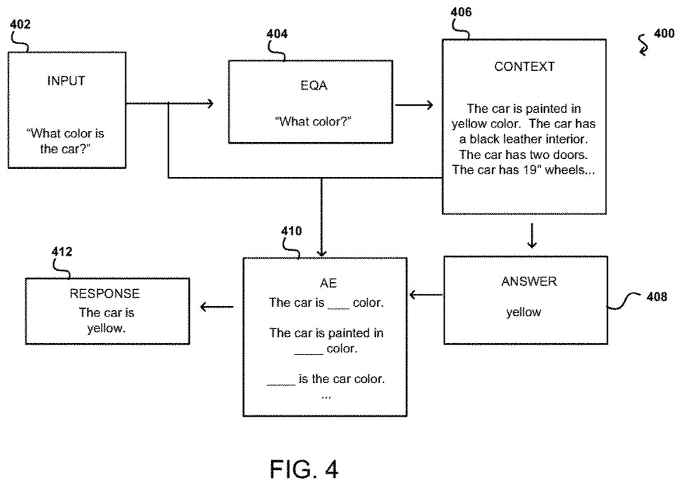

A process flow 500 to provide a response to a query is illustrated in FIG. 4. In at least one embodiment, various software modules may be utilized to perform different steps of the illustrated flow, where one or more components may be hosted locally on a local client or may be accessible via one or more networks, such as at a remote server or as a portion of a distributed computing environment. In this example, an input 402 starts the flow, which corresponds to a user query, which may be an utterance, a textual input, an image input, a selection, or combinations thereof. For example, the user may ask the environment “What color is the car?” This utterance may be responsive to the user interacting with an environment showing an image or rendering of a car or where the user has received information about the car and is now asking for additional information, which may be useful in forming a decision regarding the car. The input may be received by one or more local clients, for example via a microphone, and may be further processed either on the local client or using one or more remote systems.

Various embodiments utilize an EQA model 404 to determine an answer associated with the input query. The EQA model 404 may be a trained neural network that determines an intent or desired output of the input here, which in this example is shown as “What color?” and then extracts the information from a context 406, which may correspond to a corpus of information associated with an interaction environment receiving the input 402. The extracted information may be provided as the answer 408, which would answer the input 402, however, as shown, is not conversational, in this case being a single word.

In various embodiments, an AE model 410 may receive the answer 408, along with the input 402 and/or the context 406, in order to determine how to rephrase or otherwise generate a conversational response 412 to present the answer 408 to the user. For example, the AE model 410 may phrase or otherwise use the input 402 in order to generate the response 412, such as by rearranging the words within a phrase, rearranging the context of the answer, or otherwise generating the response. Accordingly, embodiments may improve the answers retrieved by the EQA model 404 by adding the AE model 410 in order to reformulate the input 402 into a conversational response 412.

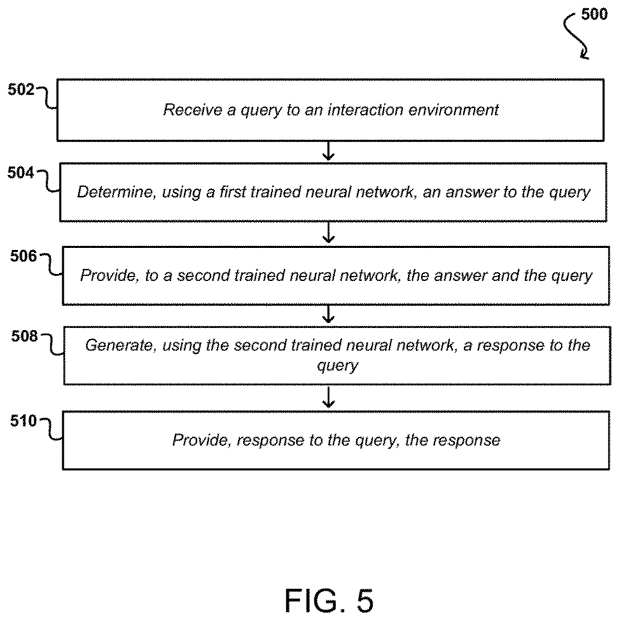

FIG. 5 illustrates an example process 500 for determining a user intent to execute an action within an interaction environment. It should be understood that for this and other processes presented herein that there can be additional, fewer, or alternative steps performed in similar or alternative order, or at least partially in parallel, within the scope of various embodiments unless otherwise specifically stated. In this example, a query is received at an interaction environment 502. The query may be an input, such as an auditory or textual input, among others. In at least one embodiment, the query includes a query or request for information associated with the interaction environment.

A first trained neural network, which may be an EQA as noted above, may determine an answer to the query 504. The answer may be extracted from a corpus of information associated with the interaction environment. For example, a provider may include information, which may be in natural language, in a list, in pairs, etc., that may be evaluated and extracted from the information. In at least one embodiment, the answer includes a span or section of the corpus of information. The answer and the query may be provided to a second trained neural network 506. The second trained neural network may be a generative model, such as the AE model described above, that reformulates the query and/or determines, from context of the answer, how to present the information to the user in a conversational way. The second trained neural network may generate a response to the query 508. The response may include the answer along with additional words or phrases, which may be based on the input query, such that the response is conversational. This response may then be provided to the user 510. In this manner, a user interaction with an interaction environment, such as a chat bot or a digital assistant, may be more conversational and/or be closer to a natural language response, rather than one word or phrase that answers the query.

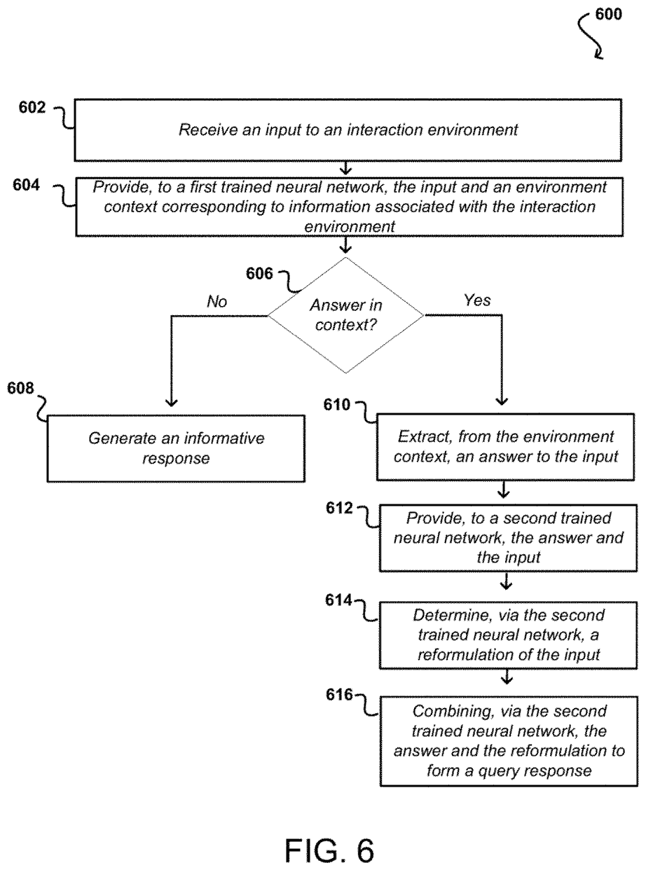

FIG. 6 illustrates an example process 600 for generating a response to an input query. In this example, an input is received to an interaction environment 602. The input may include a query, such as a question (e.g., “What is the car color?”). In at least one embodiment, the input can be a request (e.g., “Tell me common flu symptoms.”). The query may be provided to a first trained neural network, such as the EQA model, along with an environment context 604. The environment context may include a corpus of information associated with the interaction environment, such as information that may be answered while using the interaction environment. This information may be processed by the EQA model to determine whether or not the answer to the query is within the environment context 606. If not, an informative response may be generated to inform the user that no response to their query can be provided 608. In this manner, the EQA model will not provide unreliable information, such as information learning during a training phrase, thereby increasing the accuracy of the system.

If the answer is within the context, the answer may be extracted from the environment context 610. In at least one embodiment, the answer may correspond to a span, including words or phrases. The answer itself may be extracted or an entire sentence or span that includes the answer may be extracted. The answer may be provided to a second trained neural network, such as the AE model, along with the input query 612. The AE model may be a generative model that determines a reformulation of the input 614, where the reformulation may change an ordering of the words or otherwise rearrangement portions of the input in order to provide a conversational response. In at least one embodiment, the second trained neural network combines the answer with the formulation in order to generate a query response 616. As a result, the user may receive a conversational reply to their input, which may improve a user experience with the interaction environment.

### Data Center

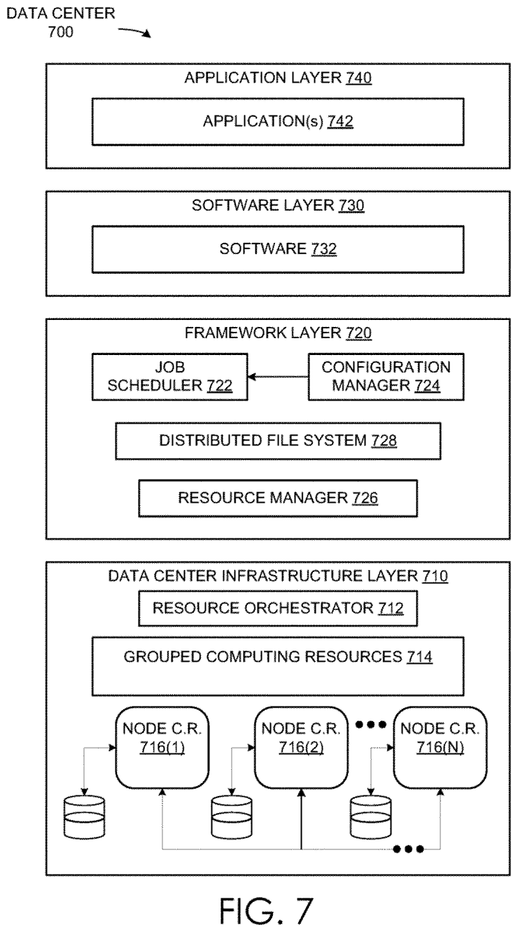

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used for executing commands in interaction environments.

### Computer Systems

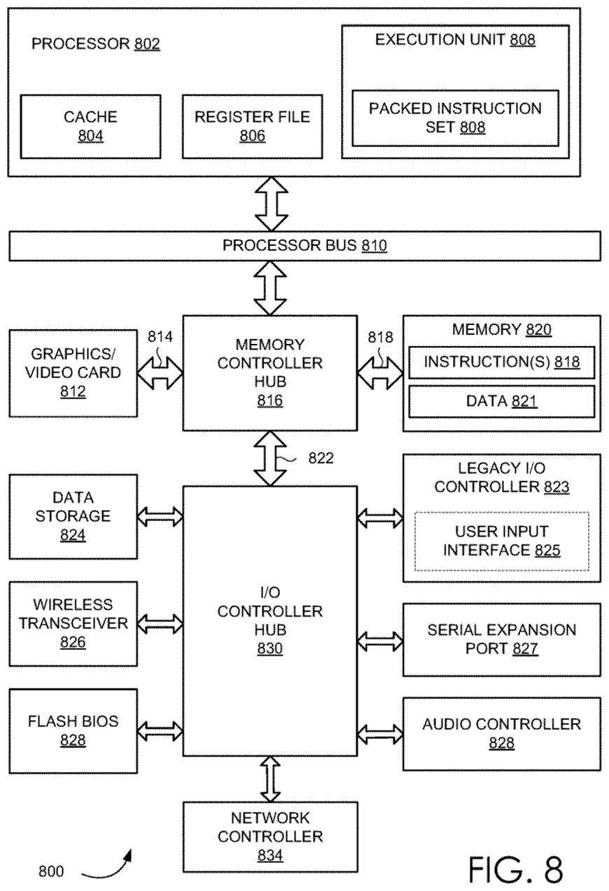

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), edge computing devices, set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Such components can be used for executing commands in interaction environments.

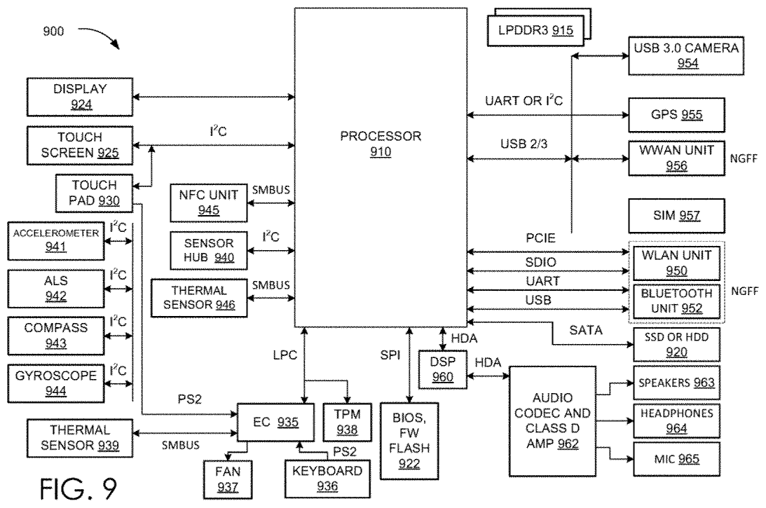

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 946, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components can be used for executing commands in interaction environments.

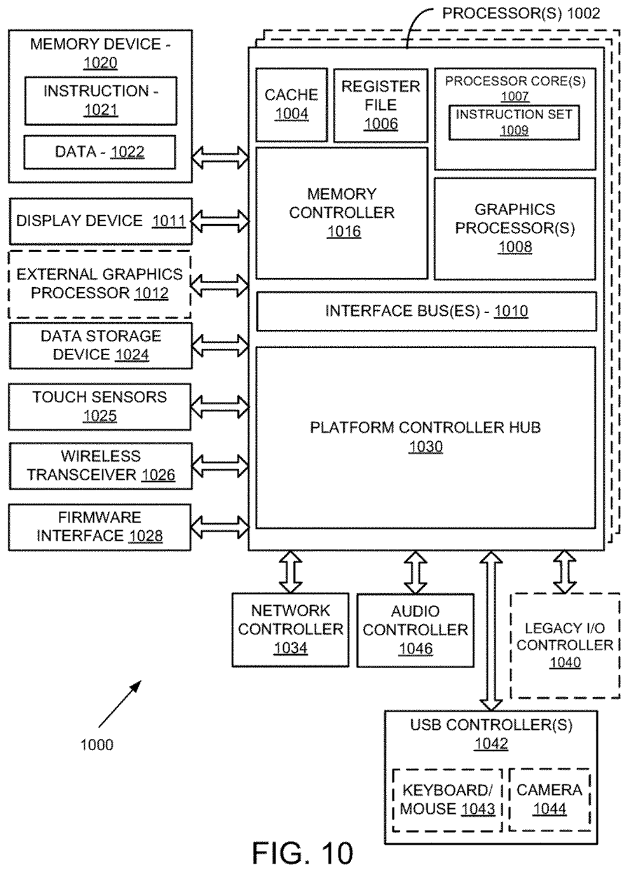

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system or datacenter having a large number of collectively or separably managed processors 1002 or processor cores 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a cloud computing host platform, a virtualized computing platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, edge device, Internet of Things (“IoT”) device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, can be a processor bus, such as a version of a Direct Media Interface (DMI) bus. In at least one embodiment, interface 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Such components can be used for executing commands in interaction environments.

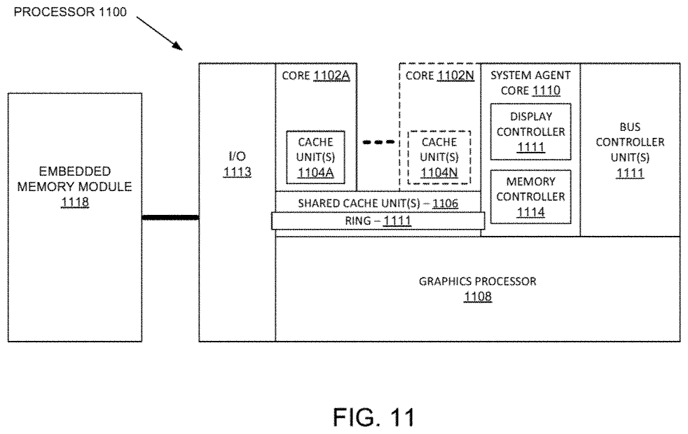

FIG. 11 is a block diagram of a processor 1100 having one or more processor cores 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Such components can be used for executing commands in interaction environments.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be any processor capable of general purpose processing such as a CPU, GPU, or DPU. As non-limiting examples, “processor” may be any microcontroller or dedicated processing unit such as a DSP, image signal processor (“ISP”), arithmetic logic unit (“ALU”), vision processing unit (“VPU”), tree traversal unit (“TTU”), ray tracing core, tensor tracing core, tensor processing unit (“TPU”), embedded control unit (“ECU”), and the like. As non-limiting examples, “processor” may be a hardware accelerator, such as a PVA (programmable vision accelerator), DLA (deep learning accelerator), etc. As non-limiting examples, “processor” may also include one or more virtual instances of a CPU, GPU, etc., hosted on an underlying hardware component executing one or more virtual machines. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
receiving a query to an interaction environment;
determining, using a first trained neural network, an answer to the query;
providing, to a second trained neural network, the answer and the query;
generating, using the second trained neural network, a response to the query, the response corresponding to a conversational reformulation of the query and the answer; and
providing, responsive to the query, the response.

2. The computer-implemented method of claim 1, wherein the first trained neural network is an extractive question answer model.

3. The computer-implemented method of claim 1, wherein the second trained neural network is a task-specific generative model.

4. The computer-implemented method of claim 3, wherein an output of the generative model is restricted based, at least in part, on the query.

5. The computer-implemented method of claim 1, wherein the query is at least one of a user-provided auditory input or a user-provided textual input.

6. The computer-implemented method of claim 1, wherein the first trained network and the second trained network are arranged in a sequential pipeline.

7. The computer-implemented method of claim 1, further comprising:
determining one or more components of the query; and
rearranging at least one component of the one or more components to generate the conversational reformulation.

8. The computer-implemented method of claim 1, further comprising:
receiving, using the first trained neural network, a provided context corresponding to information associated with the interaction environment.

9. The computer-implemented method of claim 8, further comprising:
receiving a second query to the interaction environment;
determining, using the first trained neural network, a second answer is not within the provided context; and
generating an informative responsive indicative of an error regarding the second answer.

10. A method, comprising:
determining, using a corpus of information, an answer to an input query;
determining, using at least the input query, a reformulation of the input query;
generating, based at least in part on the reformulation of the input query and the answer, a response to the input query, wherein the response presents the answer in a conversational format with at least one component of the input query being rearranged.

11. The method of claim 10, wherein the answer is determined using a trained extractive question answer model.

12. The method of claim 10, wherein the reformulation of the input query is determined using a generative model.

13. The method of claim 10, further comprising:
receiving an input query; and
providing, to a first machine learning system, the input query and the corpus of information.

14. The method of claim 10, wherein the reformulation of the input query is restricted based at least in part on the input query.

15. The method of claim 10, further comprising:
providing the response as at least one of an auditory output or a textual output.

16. A processor, comprising:
one or more processing units to:
receive a query associated with an interaction environment;
determine, using a first trained neural network, an answer to the query, the answer being extracted from a set of interaction environment information;
determine, using a second trained neural network, one or more components of the query;
determine, using the second trained neural network, a query reformulation, the query reformulation changing a sentence position of at least a portion of the one or more components;
combine the answer with the query reformulation to form a response; and
provide, responsive to the query, the response.

17. The processor of claim 16, wherein the first trained neural network is an extractive question answer model.

18. The processor of claim 16, wherein the one or more processing units are further to:
receive a second query;
determine, using the first trained network, a second answer is not within the set of interaction environment information; and
provide, responsive to the second query, a message indicative of an inability to respond to the second query.

19. The processor of claim 16, wherein the one or more processing units are further to provide the answer to the second trained neural network.

20. The processor of claim 16, wherein the second trained neural network is a generative model.
